(19) United States
(12) Patent Application Publication
(10) Pub. No.: US 2006/0031362 A1
(43) Pub. Date: Feb. 9, 2006

(54) Method and apparatus for instant messaging

(75) Inventors: Joseph Kuruvilla Chacko, Winchester (GB); David Lee Gelder, Scotwick (GB); Alasdair Nottingham, Southampton (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, ARMONK, NY (US)

(21) Appl. No.: 11/169,094

(22) Filed: Jun. 28, 2005

(30) Foreign Application Priority Data
Jul. 1, 2004 (GB) 0414715.3

(51) Int. Cl. G06F 15/16; G06F 17/30

(52) U.S. Cl. 709/206; 707/200

(57) ABSTRACT

This invention relates to a method, apparatus and computer program product for instant messaging, the method comprising: receiving more than one user message from one or more instant messaging applications; defining a user message structure based on the creation time of each message; displaying the messages in the defined structure including order and hierarchical level; determining a user selection of a first message and second message wherein the second message does not follow directly after the first message in the message structure; changing the message structure so that the second message follows directly after the first message and is moved to a selected hierarchical level relative to the first message; and redisplaying the messages in the changed message structure.

This invention pertains to computers, computer software and other information technology systems and, more particularly, to such a system, method adapted for instant messaging.

BACKGROUND of the INVENTION

In an instant messaging system, see FIG. 1, a user 1A commands messaging application 2A to send and receive messages to or from any of the messaging applications 2B . . . 2N for other users 1B . . . 1N over the network 3. Given a strictly sequential chain of messages, it is possible to communicate conversation structure by putting the structure in the content of the message so that the other users 1B . . . 1N can understand, however, in real time chat this spoils the flow of the dialogue. In most instant messaging systems, multiple threads of discussion exist even for conversations between two people and confusion can occur between threads. A simple answer such as “yes”, if it arrives fractionally too late, looks like the answer to a different thread and conveys the wrong meaning. Time is wasted explaining which thread the “yes” was in response to. More time is wasted if a misunderstanding arises and is not resolved.

### SUMMARY OF INVENTION

According to a first aspect of the present invention there is provided a method in an instant messaging system, said method comprising: receiving more than one message; defining a message structure based on the timing of each message; displaying the messages according to the defined structure; determining a user selection of a first message and second message whereby the second message does not follow directly after the first message in the message structure; changing the message structure of the user selected messages so that the second message follows directly after the first message; and redisplaying the messages according to the changed message structure.

By changing the displayed message order, a conversation's structure can be represented despite the asynchronous nature of online chat. This is useful in multi-user chat sessions as well as one-to-one conversations. This solution improves on the prior art by adding support for a dynamic conversation structure. Structure is a part of a conversation usually expressed through intonation, gestures and timing which are easily lost in text-based, asynchronous communication. With the present solution, it is possible to correlate and re-correlate messages after they have been sent and received. All messages are initially correlated in a first structure. A first message marks the beginning of a conversation and subsequent messages will have a predecessor message and so the system correlates any new message to the last message sent. If this is done with respect to when the user first begins the message, as opposed to when the user completes and dispatches the message, a closer approximation to the user's intentions will be captured and conveyed to other users.

Therefore the message order may be based on the time when each message is sent. Alternatively and advantageously the message order may be based on the time when each message is created.

Advantageously the method further comprises: marking the second message as indented from the first message; and redisplaying the messages in the indented and changed message order.

A graphical user interface may display a small margin containing a bullet point for each message in a instant messaging session and these bullets can be dragged and dropped by the user onto each other to indicate correlation between messages. Alternatively, a whole message may be dragged and dropped on to another message.

Any changes in the ordering of the messages is propagated to all the users in a conversation. Correlations are generated by user interactions as described above. Changes to the message structure are propagated as control messages around the instant messaging system so that each control message arrives at each messaging application once, in the same way as any other messages are propagated around the messaging system.

In order to generate a piece of correlative information, a user should be the originator of the message.

Only two messages are involved in a correlation. The graphical user interface (GUI) represents that the association is unique, so the user understands that a change in correlation, not an additional correlation, has occurred.

No closed message referencing is allowed, i.e. a message B cannot be in response to message A if message A is already in response to message B, either directly or indirectly.

### DESCRIPTION OF DRAWINGS

In order to promote a fuller understanding of this and other aspects of the present invention, an embodiment of the invention will now be described, by means of example only, with reference to the accompanying drawings in which:

FIG. 1 is an overview of a basic instant messaging system;

FIG. 2 is a more detailed diagram of FIG. 1, including control messages according to the preferred embodiment;

FIG. 3 is a class diagram of the structure required for the preferred embodiment;

FIG. 4 is a method flow diagram of the present embodiment;

FIG. 5 is a sequence diagram of an example conversation in the preferred embodiment; and

FIG. 6A is a representation of a display of the three messages of FIG. 5 before correlation; and

FIG. 6B is a representation of a display of the same three messages after correlation.

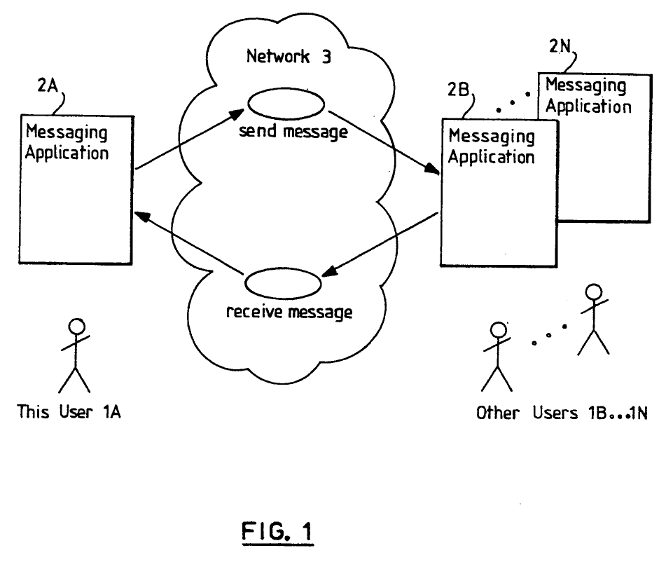

### DESCRIPTION OF THE ILLUSTRATIVE EMBODIMENTS

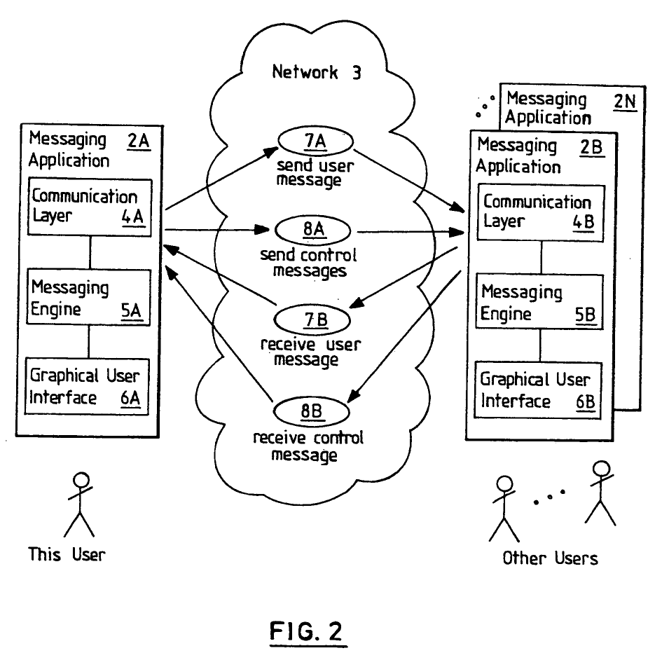

FIG. 2 is a use case diagram of an instant messaging system according to the preferred embodiment. In an instant messaging system a user commands messaging application 2A to send and receive messages from any of the messaging applications 2B . . . 2N over network 3. Each messaging application 2A . . . 2N comprises: a communication layer 4(4A . . . 4N); a messaging engine 5(5A . . . 5N); and a graphical user interface (GUI) 6(6A . . . 6N). Each messaging application 5A . . . 5N can send messages 7(7A,7B) and 8(8A,8B): the first message in a conversation is the first predecessor message and the next message is the first successor message, each user message is a successor to the preceding message (if there is one) and a predecessor to the succeeding message (if there is one). Each messaging application 5A . . . 5N can send a control message 8A, 8B to correlate a received user message 7A,7B, that is force an existing user message to be a successor of another user message. Each messaging application can receive user messages 7A,7B and control messages 8A,8B.

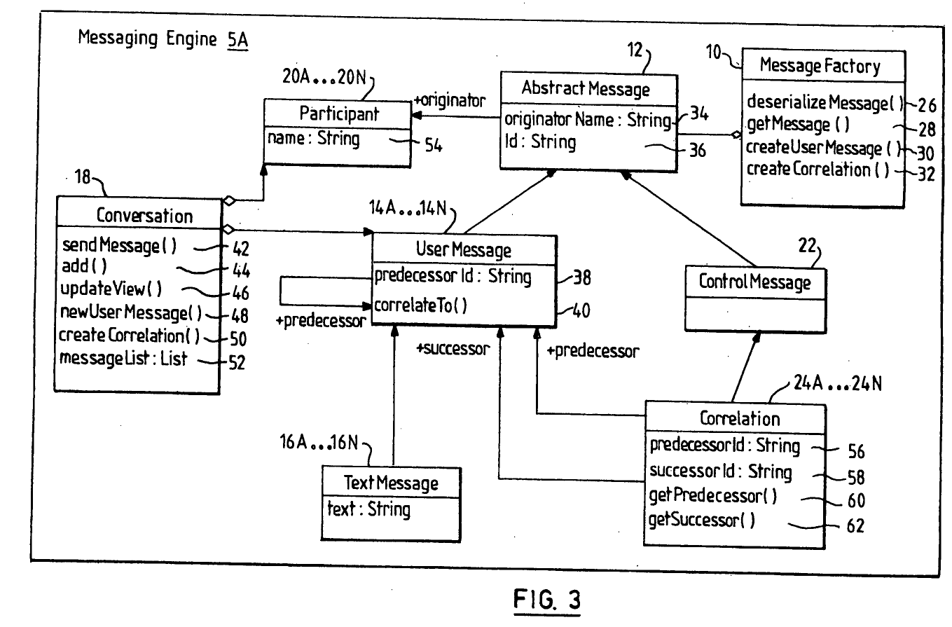

FIG. 3 illustrates the object structure of the messaging engine required for the preferred embodiment. The messaging engine 5A comprises the following objects: MessageFactory 10; AbstractMessage 12; UserMessages 14A to 14N; TextMessage 16; Conversation 18; Participants 20A TO 20N; ControlMessage 22; and Correlations 24A . . . 24N.

The MessageFactory 10 comprises: a deserializeMessage( ) method 26; a getMessage( ) method 28; a createuserMessage( ) method 30; and a createCorrelation( ) method 32. The deserializeMessage( ) 26 takes a string of serialized bits as an input from a Conversation 18 and deserializes it to form a UserMessage 14A with an id for the Conversation 18; the UserMessage 14A is stored at some memory reference and its id returned as output of the method. The getMessage( ) method 28 takes a message id as input and returns the associated UserMessage 14A memory reference as output. The createUserMessage( ) method 30 creates a UserMessage 14A from the appropriate class, stores it at some memory reference and returns the id of the new object. The createCorrelation( ) method 32 creates a new Correlation object 24A and returns the id of the new object. The MessageFactory 10 also consists of the AbstractMessage class 12 (see the white diamond arrow) which gives it the ability to create UserMessages 14A . . . 14N and Correlations 24A . . . 24N.

The AbstractMessage class 12 is the base class (as indicated by the white triangle arrows) for the UserMessage 14A . . . 14N, TextMessage 16A . . . 16N, Control Message 22 and Correlations 24A . . . 24N. An identifier for the originator of a message based on this class is stored in a string called originatorName 34. This originatorName identifier references a Participant object (as indicated by the +originator arrow). An identifier for the message based on this class is stored in a string called id 36.

The UserMessage 14A . . . 14N adds a predecessorId string 38 and a correlateTo( ) method 40 to the AbstractMessage class 12. The predecessorId 38 contains the Id of a previous UserMessage as indicated by the self referencing +predecessor arrow. The correlateTo( ) method 40 takes a new predecessor as an argument and swops this for the value in the predecessorId string 38, the existing predecessor id is returned to the calling routine.

A TextMessage 16A . . . 16N is a type of UserMessage that additionally comprises a string for the text of the message. Other types of UserMessage include messages that contain files, pictures, voice messages or combinations of these. In this description UserMessage is used generically to describe all messages except in the example which is text.

A Conversation object 18 represents a generalized conversation of messages between several Participants 20A . . . 20N. The Conversation 18 comprises a sendMessage( ) method 42; an add( ) method 44; an update view( ) method 46; a newUserMessage( ) method 48; a newCorrelation( ) method 50 and a messageList 52. The Conversation 18 further consists of Participants 20A . . . 20N and the UserMessages 14A . . . 14N. A Conversation 18 represents a specific conversation; the Conversation 18 has one or more Participant objects 20A . . . 20N associated with it and zero or more UserMessages 14A . . . 14N associated with it. The sendMessage( ) method 42 receives a serialized bit stream from the communication layer 4 and calls the deserializeMessage method 26 of the MessageFactory 10. The Id 36 of the UserMessage 14A is returned. The add( ) method 44 takes the UserMessage Id 36 and adds it to the messageList 52. The updateView( ) method 46 calls the GUI 6 with the messageList 52 as a parameter to update the display with the changed messageList 52. The newUserMessage( ) method 48 accepts an user input from the GUI 6 when a a new message is be sent; this method requests the MessageFactory createUserMessage 30 to create a new message for the Conversation 18; the id of the new message is returned. The Correlation( ) method 50 accepts user input from the GUI 6 when a message is to be correlated. Two types of Correlation object 24 are possible: a default correlation and a special correlation and the particular type is indicated by including a indent tag as a parameter when the method is invoked.

A Participant 20A . . . 20N comprises a name string 54 for storing the name of the participant. Each Participant 20A . . . 20N instantiated from this class will represent a participant in a conversation.

A ControlMessage 22 is a type of AbstractMessage 12 and a Correlation 24 is a type of ControlMessage 22.

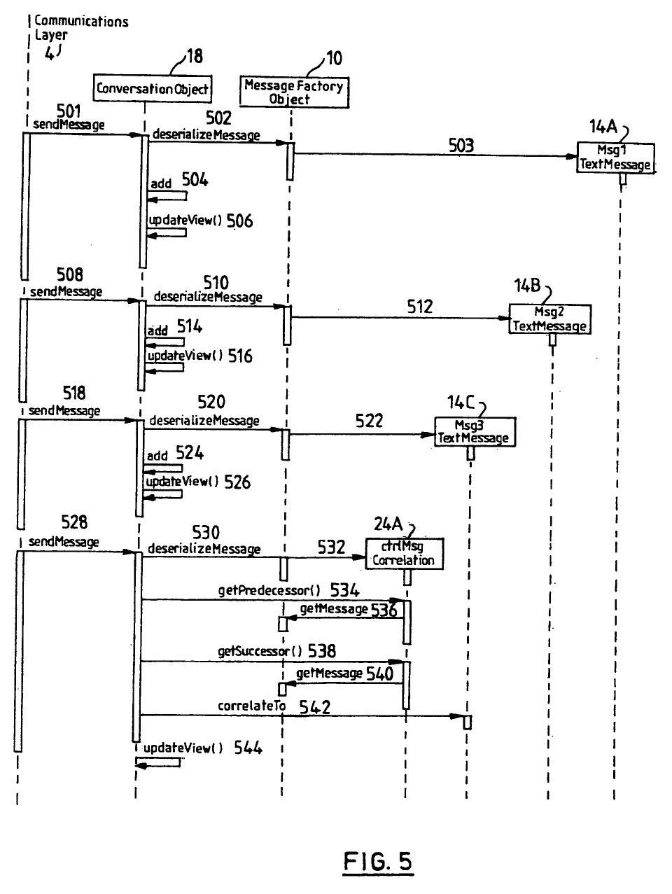

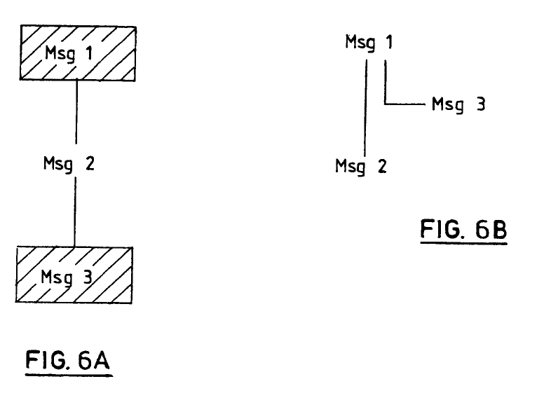

The Correlation 24 comprises: a predecessorId string 56; a successorId string 58; a getPredecessor( ) method 60; and a getSuccessor( ) method 62. A Correlation 24 instantiated is a specific control message for changing the successor of a pre-existing UserMessage 14 in an originator messaging application 2A and in the messaging applications 2B . . . 2N of the other participants. A user invokes the Correlation method 50 after using the GUI 6 to select two messages (e.g. msg1 and msg3 in FIG. 6A): the predecessor (msg1 in FIGS. 5, 6A and 6B) and a successor (msg3 in FIGS. 5, 6A and 6B). The Id's of the selected messages are stored in the predecessorId 56 and the successorId 58 in the newly created Correlation 24. If the successor message is to be indented (as in FIG. 6B) then an indent tag is stored in the successorId string 58. The getPredecessor( ) method 60 acquires the memory reference from the MessageFactory 10. The getPredecessor( ) method 60 and the getSuccessor( ) method 62 return the memory references of the predecessor and successor messages respectively. The predecessor memory reference is passed to the correlateTo( ) method 40 of the UserMessage at the successor memory reference.

All UserMessage 14A . . . 14N have a unique id and this id will be the same on all client processes even if the memory references are different. The UserMessage is enhanced to include a predecessor message id. A predecessor id is identified on creation of a UserMessage 14A and that predecessor is propagated to all peers by distributing the UserMessage 14A itself. The inclusion of the predecessor id is an intrinsic part of the message from its instantiation. If the predecessor id is redefined after the message was created and propagated to all clients, then the information is new data that must be shared by some other means. This new data is propagated between peer processes using the Correlation 24. When this control message is received at a peer, it is processed, the resulting link information is updated in the local Conversation, and the display is updated.

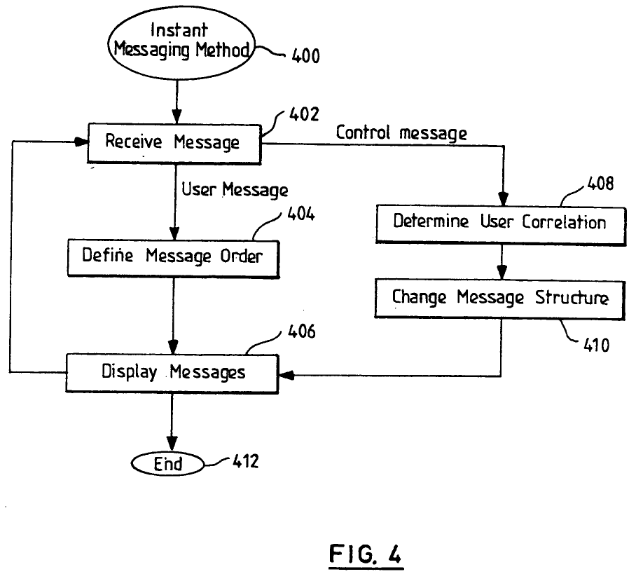

FIG. 4 is a method flow 400 of the preferred embodiment.

Step 402 the Conversation 18 receives a message and records when the message was created. In an alternative embodiment it is the time when the message is received that is recorded. On initial receipt the message is a string of bits, sendMessage( ) 42 invokes deserializeMessage( ) 26 and the message id is returned to the Conversation 18.

Step 404, if the message is a UserMessage 14 then Conversation method add( ) 44 updates the message order of the conversation according to the message creation time.

Step 406, Conversation updateView( ) method 46 displays the messages in the conversation in the defined message order. The Conversation 18 invokes the updateView( ) method 46 using the messageList 52 and message order defined by the predecessorId 38 in each UserMessage 14A . . . 14N. Standard methods in the GUI are used to render the screen image. If the conversation is still in progress then the control of the method moves back to step 402 to receive further messages, otherwise the conversation is ended at step 412.

Step 408, if the message from step 402 is a Correlation message 24 then the Conversation add( ) method 44 acquires predecessorId 56 and the successorId 58 from the Correlation.

Step 410, the add( ) method 44 changes the predecessorId 38 in the UserMessage 14 identified by the acquired successorId 58 to the determined predecessorId 56 by calling the correlateTo( ) method 40. If the Correlation 24 included an indent tag then the indent tag is included in the predecessorId. The process control moves to step 406 to update the message display.

Step 412 is the end of the process when no more messages are forthcoming.

The sequence diagram of FIG. 5 shows an example messaging peer conversation model receiving three messages from the communications system. The diagram comprises seven columns, each column representing a messaging application feature, arrows between the columns represent the interactions between the features. The columns going from left to right represent: the communication layer 4; the Conversation object 18; the messageFactory object 10; a Correlation object 24A; a third TextMessage object (msg3—14C); a second TextMessage object (msg2—14B); and a first TextMessage object (msg1—14A).

In step 501 the Communication layer 4 sends a received stream of message bits to the appropriate Conversation object 18 and triggers the sendMessage( ) method 42 to process a object bit stream. In step 502 the object bit stream is sent to the MessageFactory 10 and the deserializeMessage( ) 26 is invoked to serialize the stream. Step 503 results in the creation of msg1. In step 504 the add( ) method 44 adds msg1 to the messageList 52. In step 506 updateView( ) 46 refreshes the view to display the new message.

In step 508 the Communication layer 6 sends a received stream of message bits to the appropriate Conversation and triggers the sendMessage( ) method 42 as before. In step 510 the bit stream is sent to the MessageFactory 10 and the deserializeMessage( ) 26 is invoked as before. Step 512 results in the creation of msg2. In step 514 the add( ) method 44 adds msg2 to the messageList 52. In step 516 updateView( ) 46 refreshes the view to display msg2 with msg1.

In step 518 the Communication layer 6 sends a received stream of message bits to the appropriate Conversation object and triggers the sendMessage( ) method 42 as before. In step 520 the stream of bits is sent to the MessageFactory 10 and the deserializeMessage( ) 26 is invoked as before. Step 522 results in the creation of msg3. In step 524 the add( ) method 44 adds msg3 to the messageList 52. In step 526 updateView( ) refreshes the view to display msg3 with msg2 and msg1 as shown in FIG. 6A.

In step 528 the Communication layer 6 sends a fourth received stream of message bits to the appropriate Conversation object and triggers the sendMessage( ) method 42 as before. In step 530 the stream of bits is sent to the MessageFactory 10 and the deserializeMessage( ) 26 is invoked as before. Step 532 results in the creation of a Correlation message (ctrlMsg—24A). In this example the Correlation control message is for correlating msg3 with msg1. In step 534 the Conversation 18 invokes getPredecessor 60 on the Correlation 24A which in turn invokes (step 536) getMessage 28 in the MessageFactory, the memory reference for the message is returned to the Conversation 18. In step 538 the Conversation 18 invokes getSuccessor 62 on the Correlation 24A which in turn invokes (step 540) getMessage 28 in the MessageFactory 10, the memory reference for the message is returned to the Conversation 18. In step 542 the Conversation 18 invokes the correlateTo( ) method 40 using the ids and memory references acquired from the MessageFactory 10 and Correlation 24A. The model is updated to reflect the change and then the view is updated (step 544) and the result shown in FIG. 6B.

FIG. 6A shows the original structure of msg1, msg2 and msg3 and also indicates with shaded boxes that msg1 and msg3 have been selected by the GUI.

FIG. 6B shows the new structure of the UserMessages with msg3 shown indented and depending from msg1.

This description of the messaging application system is in terms of the receiving messages from other users in the messaging network but the same principles apply for locally generated UserMessages and Correlations by the first user.

1. A method in an instant messaging system, said method comprising:
receiving more than one message;
defining a message structure based on the timing of each message;
displaying the messages in the defined structure;
determining a user selection of a first message and a second message wherein the second message does not follow directly after the first message in the message structure;
changing the message structure so that the second message follows directly after the first message; and
redisplaying the messages in the changed message structure.

2. The method of claim 1, further comprising:
determining that the user requires the select second message to have a different structure level from the first message; and
changing the message structure so that the second message follows the first message and has a different hierarchical level to the first message.

3. The method of claim 2, wherein the different hierarchical level results in the second message displayed indented from first message structure.

4. The method of claim 1, wherein the message structure is based on the time when each message is sent or wherein the message structure is based on the time when each message is created.

5. The method of claim 1, further comprising displaying graphical representations for dragging and dropping by the user onto each other to indicate correlation between messages.

6. The method of claim 1, wherein the method runs on each of a plurality of applications in the system and any change in the structure of the messages in one application is propagated to all the applications in the system.

7. The method of claim 6, wherein control messages are propagated around the system so that each control message arrives at each application once.

8. The method of claim 1, wherein a message is in response to only one other message.

9. The method of claim 1, wherein a first message cannot be in response to a second message if the second message is already in response to the first message.

10. An instant messaging apparatus comprising:
means for receiving more than one message;
means for defining a message structure based on the timing of each message;
means for displaying the messages in the defined structure;
means for determining a user selection of a first message and second message, wherein the second message does not follow directly after the first message in the message structure;
means for changing the message structure so that the second message follows directly after the first message; and
means for redisplaying the messages in the changed message structure.

11. Apparatus as in claim 10, further comprising:
means for determining that the user requires the select second message to have a different structure level from the first message; and
means for changing the message structure so that the second message follows the first message and has a different hierarchical level to the first message.

12. Apparatus as in claim 11, wherein the different hierarchical level results in the second message displayed indented from first message structure.

13. Apparatus as in claim 10, wherein the message structure is based on the time when each message is sent or wherein the message structure is based on the time when each message is begun by the user.

14. Apparatus as in claim 1, further comprising means for displaying graphical representations for dragging and dropping by the user onto each other to indicate correlation between messages.

15. Apparatus as in claim 10, further comprising a corresponding apparatus wherein any change in the structure of the messages in the apparatus is propagated to the corresponding apparatus.

16. Apparatus as in claim 15, wherein control messages are propagated to the corresponding apparatus.

17. Apparatus in claim 10, wherein a message is in response to only one other message.

18. Apparatus as in claim 10, wherein a first message cannot be in response to a second message if the second message is already in response to the first message.

20. A computer program product for processing one or more sets of data processing tasks, said computer program product comprising computer program instructions stored on a computer-readable storage medium for, when loaded into a computer and executed, causing a computer to carry out the steps of:
receiving more than one message;
defining a message structure based on the timing of each message;
displaying the messages in the defined structure;
determining a user selection of a first message and second message wherein the second message does not follow directly after the first message in the message structure;
changing the message structure so that the second message follows directly after the first message; and
redisplaying the messages in the changed message structure.
